(19) United States
(12) Patent Application Publication
(10) Pub. No.: US 2026/0277294 A1
(43) Pub. Date: Sep. 17, 2026

(54) INFORMATION PROCESSING APPARATUS AND CONTROL METHOD

(71) Applicant: Lenovo Japan LLC, Tokyo (JP)

(72) Inventors: Tsutomu Chonan, Kanagawa (JP); Atsunobu Nakamura, Kanagawa (JP); Mao Nakabayashi, Kanagawa (JP)

(73) Assignee: Lenovo Japan LLC, Tokyo (JP)

(21) Appl. No.: 19/447,503

(22) Filed: Jan. 13, 2026

(30) Foreign Application Priority Data
Mar. 11, 2025 (JP) 2025-037984

(51) Int. Cl. G06F 1/3228; G06F 1/3234

(52) U.S. Cl. CPC G06F 1/3228; G06F 1/3234

(57) ABSTRACT

The present application is to maintain performance related to the execution of a specific application as needed. A host system operates using any one-stage power mode among multi-stage power modes different in power consumption in such a manner that, when executing processing of a specific application as a predetermined specific application program, the host system measures a processing speed of the specific application, and when the processing speed is lower than a predetermined reference speed, the host system upgrades an operating mode as a power mode used for the operation to a power mode higher in power consumption.

### CROSS-REFERENCE TO RELATED APPLICATIONS

The present application claims priority to Japanese Patent Application No. 2025-037984, filed Mar. 11, 2025, the content of which is incorporated herein by reference in its entirety.

### TECHNICAL FIELD

The present application relates to an information processing apparatus and a control method, which relates, for example, to control of power consumption required for operation of a host system.

### BACKGROUND

Information processing apparatuses such as personal computers (PCs) execute processing instructed by various application programs to implement the functions. Further, power consumption can vary depending on the function implemented. In recent years, there has been an information processing apparatus equipped with an AI (Artificial Intelligence) function to control the power state depending on the execution status.

For example, in Japanese Unexamined Patent Application Publication No. 2023-179504, there is disclosed such a method that, when receiving user input including the movement of an electronic device while a display of the electronic device is in a first power state, the power state of the display of the electronic device is changed from the first power state to a second power state, and a virtual assistant session is triggered in accordance with the determination that the power state of the display of the electronic device is changed from the first power state to the second power state.

In general, there is a trade-off between performance and power consumption of an information processing apparatus including a host system. In other words, the higher the power consumption, the higher the performance of the information processing apparatus can be achieved. On the other hand, the performance is limited as power consumption is reduced. There is a case where a large amount of computational processing is required depending on the application. In such a case, when power consumption is reduced, performance may not be achieved or the information processing apparatus may not work. On the other hand, when power consumption increases excessively, the deterioration of or damage to the information processing apparatus may be accelerated.

### SUMMARY

The present application has been made to solve the above problem, and an information processing apparatus according to the first aspect of the present application includes a host system configured to operate using any one-stage power mode among multi-stage power modes different in power consumption from each other, wherein when executing processing of a specific application as a predetermined specific application program, the host system measures a processing speed of the specific application, and when the processing speed is lower than a predetermined reference speed, the host system upgrades an operating mode as a power mode used for the operation to a power mode higher in power consumption.

The above information processing apparatus may be such that, when finishing the processing of the specific application, the host system restores the operating mode to an operating mode at the startup of the specific application.

The above information processing apparatus may also be such that the processing of the specific application includes a process of acquiring output information in response to input information using a language model, and the host system measures a speed at which the output information is provided, as the processing speed.

The above information processing apparatus may further be such that, when the operating mode is a power mode lower in power consumption than a power mode highest in power consumption among the multi-stage power modes, and the processing speed is lower than the predetermined reference speed, the host system displays an inquiry window on a display to inquire about the upgrading before upgrading the operating mode.

Further, the above information processing apparatus may be such that, when the operating mode after being upgraded is used and the processing speed is higher than the predetermined reference speed, the host system displays a second inquiry window on the display to inquire about a downgrade to a power mode lower in power consumption.

A control method according to the second aspect of the present application is a control method for an information processing apparatus configured to operate using any one-stage power mode among multi-stage power modes different in power consumption from each other, the control method including: a step of measuring a processing speed of the specific application when executing processing of a specific application as a predetermined specific application program; and a step of upgrading an operating mode as a power mode used for the operation to a power mode higher in power consumption when the processing speed is lower than a predetermined reference speed.

The above-described aspects of the present application can maintain performance related to the execution of a specific application as needed.

### BRIEF DESCRIPTION OF THE DRAWINGS

FIG. 1 is a schematic block diagram illustrating a hardware configuration example of an information processing apparatus according to one or more embodiments.

FIG. 2 is a schematic block diagram illustrating a functional configuration example of the information processing apparatus according to one or more embodiments.

FIG. 3 is a table illustrating control parameters for each power mode according to one or more embodiments.

FIG. 4 is a diagram illustrating an example of a display screen of a specific application.

FIG. 5 is a graph illustrating a relationship between the processing speed of the specific application and power consumption.

FIG. 6 is a diagram illustrating an example of an inquiry window according to one or more embodiments.

FIG. 7 is a diagram illustrating an example of another inquiry window according to one or more embodiments.

FIG. 8 is a flowchart illustrating an example of power control according to one or more embodiments.

FIG. 9 is a diagram illustrating a power mode setting screen according to one or more embodiments.

FIG. 10 is a diagram illustrating a display example of application windows according to one or more embodiments.

### DETAILED DESCRIPTION OF THE INVENTION

Embodiments of the present application will be described below with reference to the accompanying drawings.

First, the overview of an information processing apparatus 1 according to one or more embodiments of the present application will be described. In the following description, the information processing apparatus 1 is mainly a PC. However, the information processing apparatus 1 is not necessarily limited to the PC, which may also be a smartphone, a tablet terminal device, or the like.

The information processing apparatus 1 includes a host system that executes various application programs (which may also be called “applications” or “apps” in the present application). In the present application, “to execute a program” or “the execution of a program” means to execute processing directed by instructions written in the program (or the corresponding application). The host system makes power consumption variable.

The host system operates according to any one-stage power mode among multi-stage power modes different in power consumption. When executing a preset, specific application (which may also be called a “specific application” in the present application), the host system measures a processing speed related to processing of the specific application. A predetermined reference speed is set in the host system. When the measured processing speed is lower than the reference speed, the host system changes the currently-applied power mode (which may also be called the “operating mode” in the present application) to a power mode higher in power consumption. When finishing the execution of the specific application, the host system restores the power mode to a power mode used before starting the execution of the specific application.

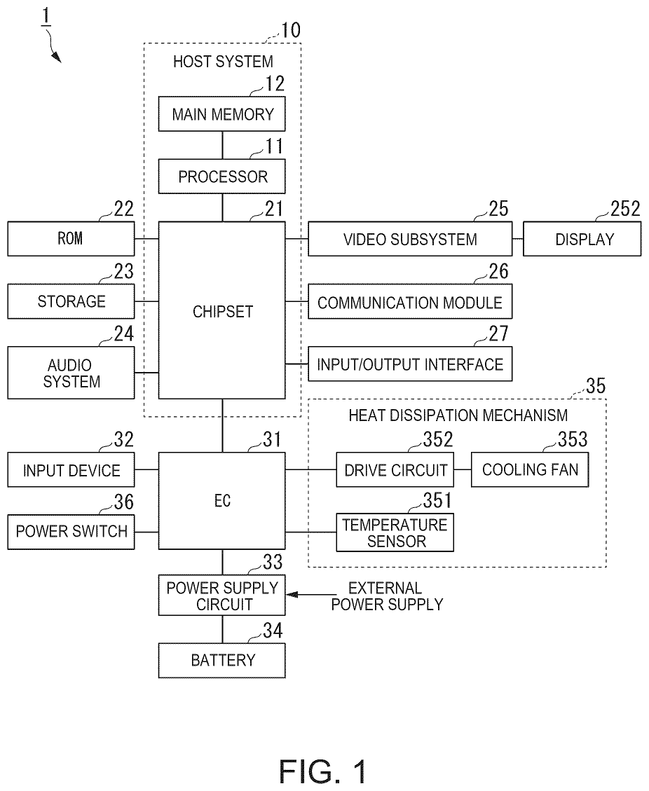

FIG. 1 is a schematic block diagram illustrating a hardware configuration example of the information processing apparatus 1 according to one or more embodiments. The information processing apparatus 1 includes a host system 10, a ROM 22, a storage 23, an audio system 24, a video subsystem 25, a display 252, a communication module 26, an input/output interface 27, an EC 31, an input device 32, a power supply circuit 33, a battery 34, a heat dissipation mechanism 35, and a power switch 36. The host system 10 is a computer system that constitutes the core of the information processing apparatus 1. The host system 10 includes a processor 11, a main memory 12, and a chipset 21. The processor 11 and the main memory 12 are minimum hardware components to configure the host system 10. The heat dissipation mechanism 35 dissipates heat generated inside the information processing apparatus 1. The heat dissipation mechanism 35 includes a temperature sensor 351, a drive circuit 352, and a cooling fan 353.

The processor 11 is a core processing unit that executes various kinds of arithmetic processing directed by instructions written in software (program). The processes executed by the processor 11 include reading and writing data from and to storage media such as the main memory 12 and the storage 23, input/output with other devices, and the like. At least one CPU (Central Processing Unit) is included in the processor 11. The CPU controls the overall operation of the information processing apparatus 1. For example, the CPU executes processing of programs such as an OS (Operating System), firmware, device drivers, utilities, and applications.

The main memory 12 is a writable memory used as reading areas of execution programs of the processor 11 or working areas to which processed data of the execution programs are written. For example, the main memory 12 includes plural DRAM (Dynamic Random Access Memory) chips.

The chipset 21 includes plural controllers connectable to plural devices to be able to input and output various data. For example, each of the controllers is any one or a combination of bus controllers such as USB (Universal Serial Bus), serial ATA (AT Attachment), an SPI (Serial Peripheral Interface) bus, a PCI (Peripheral Component Interconnect) bus, a PCI-Express bus, and an LPC (Low Pin Count) bus. The devices as connection destinations include the ROM 22, the storage 23, the audio system 24, the video subsystem 25, the communication module 26, the input/output interface 27, and the EC 31.

The ROM (Read Only Memory) 22 mainly stores system firmware, firmware that controls the operation of the EC 31 and other devices, and the like. For example, the ROM 22 may be either an EEPROM (Electrically Erasable Programmable Read Only Memory) or a flash ROM.

The storage 23 is an auxiliary storage that stores various data used for processes of the processor 11 and other devices, various data acquired by the processes, various programs, and the like. For example, the storage 23 may be either one or a combination of an SSD (Solid State Drive), an HDD (Hard Disk Drive), and the like.

A microphone and a speaker (not illustrated) are connected to the audio system 24 to record, play back, and output audio data. Note that the microphone and the speaker may be built in the information processing apparatus 1, or may be separate from the information processing apparatus 1.

The video subsystem 25 is a subsystem for implementing a function related to image display. The video subsystem 25 includes a video controller and a video memory. The video controller processes drawing instructions sent from the processor 11, and writes and temporarily stores drawing information obtained by the drawing instructions into the video memory. The video controller reads the drawing information stored in the video memory based on a predetermined frame rate, and outputs the read drawing information to the display 252 as display data indicative of display information (image processing). The video subsystem 25 may be configured to include one or more GPUs (Graphic Processing Units) or coprocessors. The GPU is a processor mainly responsible for real-time image processing and other parallel computing. The GPU sometimes shares some processes with the CPU. The GPU may be integrated with the CPU as the processor 11 and formed on the same core, or may be formed on a core separate from the CPU. The GPU may execute parallel computing other than the image processing, or may share some processes with the CPU.

The display 252 displays a display screen based on display data input from the video subsystem 25. For example, the display 252 may be either a liquid crystal display (LCD) or an OLED (Organic Light Emitting Diode) display.

The communication module 26 connects to a communication network wirelessly or by wire. The communication module 26 communicates various data with other devices connected to the communication network. For example, the communication module 26 includes a wireless LAN (Local Area Network) that enables sending and receiving various data between devices according to a predetermined wireless communication system (for example, IEEE802.11). In the wireless LAN, communication between devices is performed via an access point.

The input/output interface 27 connects to various devices such as peripheral devices wirelessly or by wire. The input/output interface 27 is, for example, a connector for inputting and outputting data by wire according to the USB specification.

The EC (Embedded Controller) 31 is a one-chip microcomputer that monitors ad controls various devices (peripheral devices, sensors, and the like) regardless of the operating state of the system of the information processing apparatus 1. The EC 31 includes a CPU separate from the processor 11, a ROM, a RAM, multi-channel A/D input terminal and D/A output terminal, a timer, and digital input/output terminals (not illustrated). For example, the input device 32, the power supply circuit 33, the temperature sensor 351, the drive circuit 352, the power switch 36, and the like are connected to input/output terminals of the EC 31.

The input device 32 detects a user operation and outputs, to the EC 31, an operation signal according to the detected operation. The input device 32 includes, for example, any one or a combination of a keyboard, a touchpad, and the like. The input device 32 may also be a touch sensor, which may be configured as a touch panel overlapping with the display 252.

The power supply circuit 33 converts the voltage of DC power, supplied from an external power supply or the battery 34, to voltage required for the operation of each of devices that construct the information processing apparatus 1, and supplies the power having the converted voltage to the device as the supply destination. The power supply circuit 33 supplies power to each device under the control of the EC 31. The power supply circuit 33 includes a converter for converting the voltage of power supplied to the own circuit, and a power feeder for charging the battery 34 with the power having the converted voltage. The power feeder charges the battery 34 with remaining power supplied from the external power supply and unconsumed in each device. When no power is supplied from the external power supply, or when power supplied from the external power supply is insufficient, the power feeding device supplies power discharged from the battery 34 to each device as operating power.

The battery 34 is charged with power supplied from the power supply circuit 33 or discharges power into the power supply circuit 33. For example, the battery 34 may be a lithium ion battery, a sodium ion battery, or the like.

The temperature sensor 351 detects the temperature of the own unit, and outputs a temperature signal indicative of the detected temperature to the EC 31. For example, the temperature sensor 351 may also be placed in close proximity to the processor 11 within a specified distance from the processor 11. In this case, the temperature of the processor 11 is detected to protect the heat generation of the processor 11.

The drive circuit 352 supplies power, supplied from the power supply circuit 33 to the own unit, to the cooling fan 353 under the control of the EC 31. Thus, the operation of the cooling fan 353 is controlled.

The cooling fan 353 dissipates heat generated in the information processing apparatus 1. The cooling fan 353 is equipped with a motor that consumes power supplied from the drive circuit 352 to rotate fan blades in order to draw air into the housing of the information processing apparatus 1. The incoming air exchanges heat with each unit of the information processing apparatus 1, and then is exhausted from the housing.

Each time a press operation is accepted, the power switch 36 controls the power supply state to either Power ON or Power OFF for the entire system of the information processing apparatus 1. When accepting the press operation, the power switch 36 outputs, to the EC 31, a press signal indicative of the press. When the information processing apparatus 1 is in the Power OFF state and the press signal is input from the power switch 36, the EC 31 causes the power supply circuit 33 to start supplying power to each device of the information processing apparatus 1 (Power ON). When detecting the start of power supply to the own unit, the processor 11 reads system firmware from the ROM 22 and loads the system firmware into the main memory 12 to execute bootup processing (Boot) according to the instructions written in the system firmware. In the bootup processing, the processor 11 loads, into the main memory 12, data that was saved to the storage 23. Then, the processor 11 boots the OS, and after the OS bootup processing is completed, the processor 11 starts executing device drivers related to control of devices such as the storage 23, the communication module 26, the input/output interface 27, and the like.

On the other hand, when power is supplied to the information processing apparatus 1 and the press signal is input from the power switch 36, the EC 31 causes the processor 11 to execute shutdown processing (Shutdown). In the shutdown processing, the processor 11 saves, to the storage 23, data present in a working area at the time. After the data saving is completed, the processor 11 stops processing by apps, device drivers, and other programs running at the time. After that, the processor 11 notifies the EC 31 of the completion of the shutdown processing. The EC 31 causes the power supply circuit 33 to cut off the power supply to each device of the information processing apparatus 1.

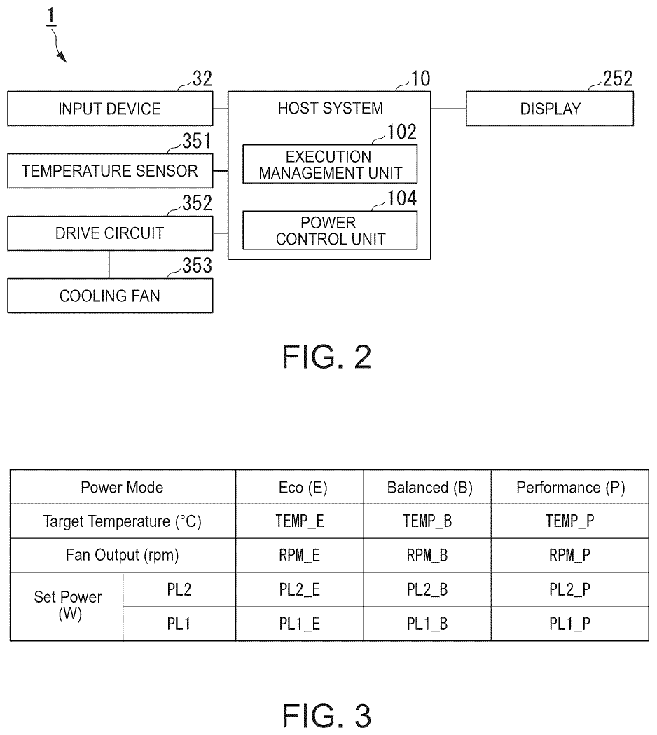

Next, a functional configuration example of the information processing apparatus 1 according to one or more embodiments will be described. FIG. 2 is a schematic block diagram illustrating the functional configuration example of the information processing apparatus 1 according to one or more embodiments.

The information processing apparatus 1 includes the host system 10.

In the host system 10, the processor 11 executes various programs to realize the functions in collaboration with hardware such as the main memory 12, the chipset 21, the EC 31, and the like.

The host system 10 is a computer system that executes the OS to manage the execution of other programs such as apps, manage computing resources such as memories and processes, manage input/output with each device, and the like. The host system 10 determines, as an operating mode, any one-stage power mode among the predetermined multi-stage power modes to operate according to the operating mode. The host system 10 identifies control parameters related to the determined operating mode from among control parameters prestored for each power mode in a register of the processor 11. The host system 10 controls power consumption using the identified control parameters. Further, the EC 31 refers to driving parameters prestored in the own ROM to identify a driving parameter related to the operating mode determined by the host system 10. The EC 31 causes the drive circuit 352 to drive the cooling fan 353 using the identified driving parameter. An example of power modes will be described later.

The host system 10 includes an execution management unit 102 and a power control unit 104.

The execution management unit 102 can execute one or more applications at the same time under the OS's multitasking environment. For example, the execution management unit 102 starts executing an application corresponding to an icon selected according an operation from among icons displayed on the display 252. The execution management unit 102 may also start executing an application preset as a startup application after the bootup processing of the host system 10 is completed. In the present application, “to operate or to execute processing based on an operation signal to be input” may also be called “to . . . according to an operation” or “. . . according to an operation.”

When plural applications are running, the execution management unit 102 determines any one application as a foreground process, and determines the other applications as background processes.

The execution management unit 102 fits display screens generated according to running applications to windows and displays the windows on the display 252. The execution management unit 102 sets a window of the foreground process (which may also be called an “active window” in the present application) as the operation target. In other words, the execution management unit 102 accepts an operation signal indicative of coordinates within the active window as input to the foreground process, and ignores operation signals indicative of coordinates within the other windows.

The execution management unit 102 displays the active window on the display 252 with priority over the windows related to the background processes (which may also called “background windows” in the present application). In other words, the execution management unit 102 displays the active window without displaying the background windows in common display areas in which the active window and the background windows overlap one another. In the example of FIG. 10, the entire active window related to application App1 as the foreground process among applications App1 to App3 appears. On the other hand, parts of the background windows related to the applications App2 and App3 as the background processes are covered with the foreground window related to the application App1.

As illustrated in a lower part of FIG. 10, the execution management unit 102 may display icons indicative of running applications in a manner to be arranged on a taskbar allocated along the bottom of the display area of the display 252. For example, the execution management unit 102 selects, as a foreground process, an application corresponding to an icon selected according to an operation from among the displayed icons. The execution management unit 102 may also select, as a foreground process, an application related to a window in which coordinates within the area are indicated according to the operation at the time (at the present time).

The execution management unit 102 manages operating state information indicative of an operating state for each running application. The execution management unit 102 manages the status, the CPU utilization rate, the memory utilization rate, the disk utilization rate, and the network utilization rate for each application. As the status, information indicating whether or not the running application is the foreground process may be contained in addition to the running state. The execution management unit 102 may display, on the display 252, a screen indicative of the operating state of each running application as a task manager screen. Each time the operating state is changed, the execution management unit 102 may notify the power control unit 104 of the operating state information after being changed. Further, the execution management unit 102 may notify the power control unit 104 of the operating state information at the time as a response to an inquiry about the operating state from the power control unit 104.

The power control unit 104 controls the power mode based on an operation signal input from the input device 32 or the running application.

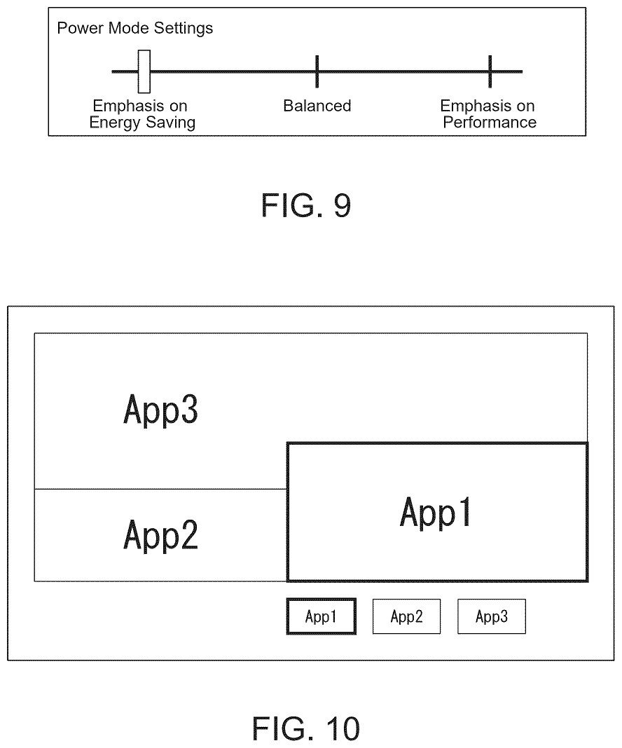

FIG. 9 is a diagram illustrating a power mode setting screen according to one or more embodiments. The setting screen illustrated in FIG. 9 is displayed to select an operating mode from among three-stage power modes according to an operation. As the three-stage power modes, Eco mode (E), Balanced mode (B), and Performance mode (P) are illustrated. In FIG. 9, phrases “Emphasis on Energy Saving,” “Balanced,” and “Emphasis on Performance” indicate the Eco mode, the Balanced mode, and the Performance mode, respectively.

The power consumption parameter (which may also be called the “set power” in the present application) related to the operation of the processor 11 varies among the three-stage power modes. The power consumption of the processor 11 increases in the order of Eco mode, Balanced mode, and Performance mode, and the power parameter of the processor 11 is so set that power consumption in the Eco mode is lowest.

FIG. 3 is a table illustrating control parameters for each power mode according to one or more embodiments.

PL1 and PL2 are used as set power examples. PL1 (Power Limit 1) is a long-term average value of the power consumption of the processor 11, which corresponds to rated power. PL2 (Power Limit 2) is a short-time average value of the power consumption of the processor 11. Both of PL1 and PL2 are parameters that allow power consumption instantaneously exceeding the values, respectively. However, PL1 is used to control the clock frequency of the processor 11 not to exceed the average value (that is, the long-term average value) of power consumption within a first observation period until the time. PL2 is used to control the clock frequency of the processor 11 not to exceed the average value (that is, the short-term average value) of power consumption within a second observation period until the time. The second observation period is set shorter than the first observation period. According to a change in operating mode, the power control unit 104 sets, to the processor 11, set power corresponding to the operating mode after being changed. The processor 11 controls power consumption based on the set power.

In general, when the power consumption of the processor 11 is high, since the amount of heat generation also increases, the need for heat dissipation increases. In the EC 31, the driving parameter to drive the heat dissipation mechanism 35 is set larger as the power parameter of the power mode is larger. In the example of FIG. 3, fan output is used as the driving parameter, and the driving parameter is so set that the output of the heat dissipation mechanism 35 becomes higher in the order of the Eco mode, the Balanced mode, and the Performance mode. The fan output corresponds to the rotation speed of the cooling fan 353. According to a change in operating mode, the power control unit 104 notifies the EC 31 of the operating mode after being changed. In the EC 31, the fan output is preset for each operating mode, and the fan output corresponding to the notified operating mode is set to the drive circuit 352.

In the power control unit 104, power mode information indicative of an execution power mode may also be preset for each application. In this case, the power control unit 104 detects an application as a startup target according to an operation and refers to the power mode information to determine a power mode corresponding to the detected application. Further, when two or more applications are executed, the power control unit 104 may select a power mode corresponding to the foreground process from among power modes corresponding to respective applications. The power control unit 104 may also determine a power mode with highest set power among the power modes respectively corresponding to plural running applications. In the power control unit 104, an initial power mode (for example, Balanced mode) may be preset to operate the processor 11 using the initial power mode unless otherwise instructed.

In the power control unit 104, specific application information indicative of a specific application is set. While the specific application is running, the power control unit 104 measures the processing speed of the specific application. As the specific application, for example, an application the power consumption of which during running constantly exceeds a predetermined percentage of the maximum power consumption of the host system 10 can be applied. As the specific application, for example, a generative AI (Artificial Intelligence) application is applied. As the generative AI application, there are a text generation tool using a large language model (LLM), an image generation tool using a generative adversarial network (GAN), and the like.

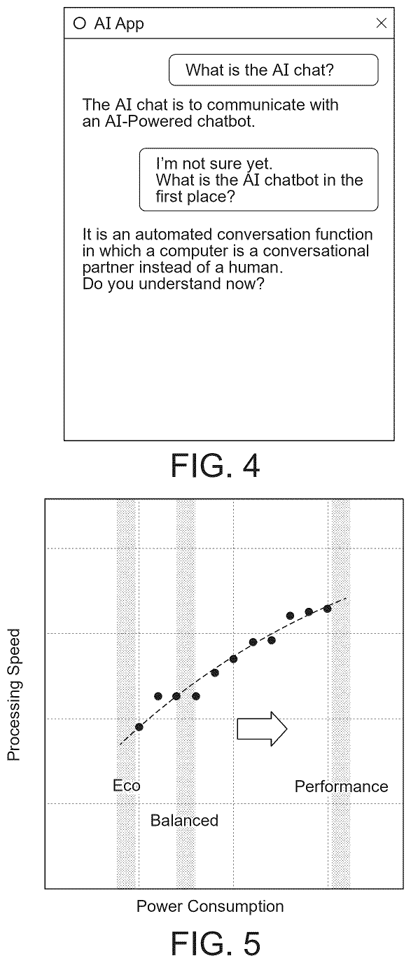

FIG. 4 is a diagram illustrating an example of the display screen of a specific application. The display screen illustrated in FIG. 4 is a display screen of a text chat as an example of the text generation tool. The text chat has a function to perform processing for generating output text corresponding to input text input in an input field of the display screen and displaying the generated output text in an output field of the display screen each time input text is acquired. For generating output text, a GPT (Generative Pre-trained Transformer) as one type of large language model is applied. Power consumption related to the operation of the large language model such as the GPT tends to be higher in power consumption than that related to any other function.

In the power control unit 104, a reference speed as a reference value of the processing speed of the specific application is set. As the reference speed, for example, the lowest processing speed at which the user can use the specific application without any trouble with or discomfort from a processing delay. The processing speed index is not particularly limited as long as throughput per unit time can be detected for each type of application. When the specific application is the generative AI, a token output speed may be used. The token output speed corresponds to the number of tokens of output information output per second. The tokens correspond to process units that make up the output information. In the example of FIG. 4, output text indicative of response text to each one input text corresponds to one token.

The power control unit 104 monitors operating state information provided from the execution management unit 102 to determine a running state of the specific application. When the running state of the specific application changes from not running to running, the power control unit 104 determines the start of running of the specific application, that is, startup of the specific application. The power control unit 104 records the operating mode applied at the time as a startup operating mode.

When the running state of the specific application is running, the power control unit 104 measures the processing speed. The power control unit 104 compares the measured processing speed with the reference speed. When the measured processing speed is equal to or more than the reference speed, the power control unit 104 maintains the operating mode applied at the time without changing the operating mode.

When the measured processing speed is lower than the reference speed, the power control unit 104 configures an inquiry window 1 for inquiring about a change (upgrade) to a power mode higher in power consumption. The power control unit 104 outputs display data indicative of the configured inquiry window 1 to the display 252 to display the inquiry window 1. When the upgrade of the operating mode is instructed according to an operation, the power control unit 104 changes the power mode to a power mode higher in power consumption. In the present application, the phrase “according to an operation” means to operate based on an operation signal input from the input device 32. As illustrated in FIG. 5, when the operating mode at the time is the Eco mode or the Balanced mode, the power control unit 104 changes the operating mode to the Performance mode. When the processing speed is lower than the reference speed, the processing speed can be accelerated by upgrading the operating mode to increase power consumption.

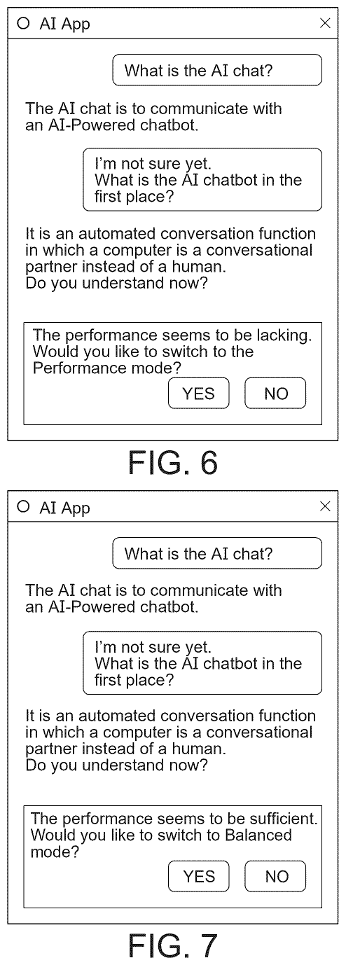

FIG. 6 is a diagram illustrating an example of the inquiry window 1 according to one or more embodiments. In the example of FIG. 6, such a state that the processing speed at the time is lower than the reference speed is notified to the user by a message saying “The performance seems to be lacking”. The user is inquired about the upgrade to the performance mode by the next message saying “Would you like to switch to the Performance mode?”. “YES” button and “NO” button are buttons that instruct and refuse the upgrade when being pressed, respectively.

Note that, when the operating mode applied at the time is the highest mode (the Performance mode in the examples of FIG. 3, FIG. 5, and FIG. 9) as a power mode highest in power consumption among the multi-stage power modes, there is no room to upgrade the operating mode. In this case, the power control unit 104 does not configure and display the inquiry window 1.

After upgrading the operating mode, when the measured processing speed is higher than the reference speed, the power control unit 104 may configure an inquiry window 2 for inquiring about a change (downgrade) to a power mode lower in power consumption. The power control unit 104 outputs display data indicative of the configured inquiry window 2 to the display 252 to display the inquiry window 2. When the downgrade of the operating mode is instructed according to an operation, the power control unit 104 changes the operating mode to a power mode lower in power consumption.

FIG. 7 is a diagram illustrating an example of the inquiry window 2 according to one or more embodiments. In the example of FIG. 7, such a state that the processing speed at that time is higher than the reference speed is notified to the user by a message saying “The performance seems to be sufficient”. The user is inquired about the downgrade to the Balanced mode by a message saying “Would you like to switch to the Balanced mode?”. “YES” button and “NO” button are buttons that instruct and refuse the downgrade when being pressed, respectively.

Note that, when the operating mode applied at the time is the lowest mode (the Eco mode in the examples of FIG. 3, FIG. 5, and FIG. 9) as a power mode lowest in power consumption among the multi-stage power modes, there is no room to downgrade the operating mode. In this case, the power control unit 104 does not configure and display the inquiry window 2.

When the running state of the specific application changes from running to not running, the power control unit 104 determines such a state that the specific application finishes running. The power control unit 104 resets the startup operating mode as an operating mode to be applied at the time.

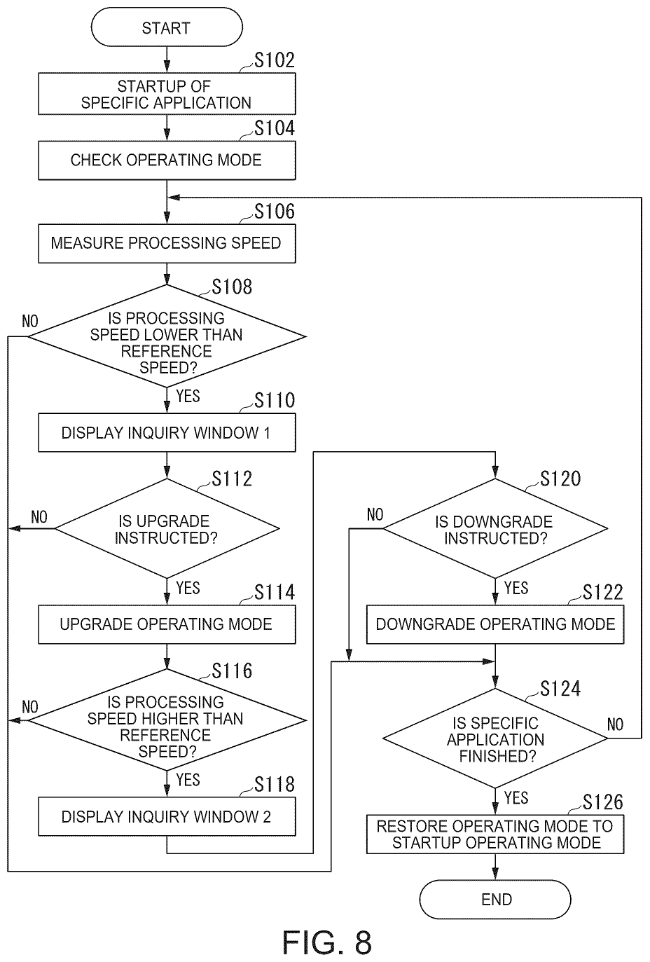

Next, an example of power control according to one or more embodiments will be described. FIG. 8 is a flowchart illustrating an example of power control according to one or more embodiments.
(Step S102) The power control unit 104 monitors operating state information indicative of the operating state for each application in the host system 10 to determine the running state of a predetermined specific application. When determining the startup of the specific application, the power control unit 104 proceeds to a process in step S104.
(Step S104) The power control unit 104 checks an operating mode applied at the time, and records the operating mode as the startup operating mode.
(Step S106) The power control unit 104 measures a processing speed related to the specific application.
(Step S108) The power control unit 104 determines whether or not the measured processing speed is lower than a predetermined reference speed. When determining that the processing speed is lower (step S108: YES), the power control unit 104 proceeds to a process in step S110. When determining that the processing speed is not lower (step S108: NO), the power control unit 104 proceeds to a process in step S124.
(Step S110) The power control unit 104 displays, on the display 252, the inquiry window 1 for inquiring about an upgrade of the operating mode.
(Step S112) The power control unit 104 monitors an operation signal input from the input device 32 to determine whether or not the upgrade of the operating mode is instructed. When the upgrade is instructed according to an operation within a certain period of time after displaying the inquiry window 1 (step S112: YES), the power control unit 104 proceeds to a process in step S114. When the upgrade is refused according to an operation, or when the upgrade is not instructed within the certain period of time (step S112: NO), the power control unit 104 proceeds to a process in step S124.
(Step S114) The power control unit 104 upgrades the operating mode to a power mode one stage higher in power consumption. The power control unit 104 sets, in the processor 11, set power corresponding to the power mode after being upgraded. The power control unit 104 notifies the EC 31 of the power mode. The EC 31 sets, in the drive circuit 352, a driving parameter corresponding to the notified power mode.
(Step S116) The power control unit 104 determines whether or not the measured processing speed is higher than the predetermined reference speed. When determining that the processing speed is higher (step S116: YES), the power control unit 104 proceeds to a process in step S118. When determining that the processing speed is not higher (step S116: NO), the power control unit 104 proceeds to the process in step S124.
(Step S118) The power control unit 104 displays, on the display 252, the inquiry window 2 for inquiring about a downgrade of the operating mode.
(Step S120) The power control unit 104 monitors an operation signal input from the input device 32 to determine whether or not the downgrade of the operating mode is instructed. When the downgrade is instructed within the certain period of time after displaying the inquiry window 2 (step S120: YES), the power control unit 104 proceeds to a process in step S122. When the downgrade is refused, or when the downgrade is not instructed within the certain period of time (step S120: NO), the power control unit 104 proceeds to the process in step S124.
(Step S122) The power control unit 104 downgrades the operating mode to a power mode one stage lower in power consumption. The power control unit 104 sets, in the processor 11, set power corresponding to the power mode after being downgraded. The power control unit 104 notifies the EC 31 of the power mode. The EC 31 sets, in the drive circuit 352, a driving parameter corresponding to the notified power mode.
(Step S124) The power control unit 104 determines whether or not the specific application is finished running depending on whether or not the running state of the specific application changes from running to not running based on the operating state information. When determining that the specific application is finished (step S124: YES), the power control unit 104 proceeds to a process in step S126. When determining that the specific application is not finished (step S124: NO), the power control unit 104 returns to the process in step S106.
(Step S126) The power control unit 104 restores the operating mode at the time to the startup operating mode. The power control unit 104 sets, in the processor 11, set power corresponding to the startup operating mode. The power control unit 104 notifies the EC 31 of the startup operating mode. The EC 31 sets, in the drive circuit 352, a driving parameter corresponding to the notified startup operating mode. After that, the processing in FIG. 8 is ended.

Note that, when the operating mode checked in step S104 is the highest mode, the procedure may proceed to step S116 by omitting the processes in step S108 to step S114.

When the operating mode checked in step S104 is the lowest mode, the procedure may proceed to step S124 by omitting the processes in step S116 to step S122.

In the example mentioned above, the host system 10 has the three-stage power modes, but the number of stages is not limited to this example. The number of stages of power modes may be two stages, or may be four stages or more.

In step S114, the operating mode is changed to a power mode one stage higher in power consumption, but the number of stages to be changed is not limited to this case. In step S114, as the difference between the measured processing speed and the reference speed becomes lager, the power control unit 104 may increase the number of stages of power modes to be changed when changing the operating mode to a power mode higher in power consumption.

In step S122, the operating mode is changed to a power mode one stage lower in power consumption, but it is not limited to this case. In step S122, as the difference between the measured processing speed and the reference speed becomes lager, the power control unit 104 may increase the number of stages of power modes to be changed when changing the operating mode to a power mode lower in power consumption.

The reference speed compared with the measured processing speed in step S108 may be equal to the reference speed compared with the measured processing speed in step S116, but it is not limited to this case. The reference speed in step S108 may be lower than the reference speed in step S116. When the operating mode is changed depending on whether or not the measured processing speed exceeds a single reference speed, the operating mode may be changed due to a temporary fluctuation in processing speed to make not only the operation of the processor 11 but also the operation of the information processing apparatus 1 unstable. Since changes in the operating mode due to frequency fluctuations in processing speed are avoided by setting the reference speed in step S108 lower than the reference speed in step S116, the operation of the information processing apparatus 1 becomes stable.

Further, in the example of FIG. 8, the running specific application is not dependent on whether it is the foreground process or the background process, but it is not limited to this case. When the specific application is running in the foreground, the processes of step S106 to step S122 may be performed, while when the specific application is running in the background, the processes of step S106 to step S122 may be omitted. Further, when the specific application is running in the background, a power mode related to another application running in the foreground may be prioritized and applied.

Note that some of the components of the information processing apparatus 1 mentioned above may be omitted, or a different component(s) may be added. For example, the display 252 and the input device 32 may be provided separately from the information processing apparatus 1 as long as various data can be sent and received wirelessly with other components of the information processing apparatus 1, or may be installed as part of a device separate from the information processing apparatus 1.

Further, the heat dissipation mechanism 35 may be omitted from the information processing apparatus 1. In this case, the setting of the driving parameter (fan output in the example of FIG. 3) for each power mode and control of the driving parameter for the heat dissipation mechanism 35 are not required.

As described above, the information processing apparatus 1 according to one or more embodiments includes the host system 10 that operates using any one-stage power mode among the multi-stage power modes different in power consumption. When executing processing of a specific application as a predetermined specific application program, the host system 10 measures the processing speed of the specific application, and when the processing speed is lower than a predetermined reference speed, the host system 10 upgrades the operating mode as the power mode used for the operation to a power mode higher in power consumption.

According to this configuration, when the processing speed of the specific application is low, the operating mode is upgraded to a power mode higher in power consumption. Therefore, performance expected to consume more power is maintained or suppressed from being degraded.

Further, when finishing the processing of the specific application, the host system 10 may restore the operating mode to an operating mode at the startup of the specific application.

According to this configuration, after the processing of the specific application is finished, the operating mode is restored to the operating mode lower in power consumption at the startup of the specific application. Since excessive power is not supplied while the processing of the specific application is not being executed, power consumption can be reduced.

Further, the processing of the specific application may have a process of acquiring output information (for example, output text) in response to input information (for example, input text) using a language model (for example, GPT), and the host system 10 may measure a speed provided by the output information (for example, a token output speed) as the processing speed.

According to this configuration, since the speed provided by the output information is evaluated as the processing speed, the power mode is controlled according to such a processing speed as to fit the intuition of a user who provides the input information and accesses the output information.

Further, when the operating mode is a power mode lower in power consumption than a power mode highest in power consumption among the multi-stage power modes, and the processing speed is lower than the predetermined reference speed, the host system 10 may display an inquiry window (for example, the inquiry window 1) on the display 252 to inquire about an upgrade before upgrading the operating mode.

According to this configuration, since the display of the inquiry window allows a user to determine whether or not to upgrade the operating mode, the user can select whether or not to maintain performance accompanied with an increase in power consumption.

When the operating mode after being upgraded is used and the processing speed is higher than a predetermined reference speed, the host system 10 may display a second inquiry window (for example, the inquiry window 2) on the display 252 to inquire about a downgrade to a power mode lower in power consumption.

According to this configuration, when the operating mode is upgraded and a processing speed higher than the reference speed is obtained, since the display of the second inquiry window allows the user to determine whether or not to downgrade the operating mode, the user can select whether or not to decrease performance accompanied with a decrease in power consumption.

While the embodiments of this invention has been described above with reference to the accompanying drawings, the specific configurations are not limited to those in the aforementioned embodiments, and design changes and the like without departing from the scope of this invention are included. Respective components described in the aforementioned embodiments can be combined arbitrarily as long as it is not contradictory, and some of the components may be omitted.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF SYMBOLS

1 information processing apparatus
11 processor
12 main memory
21 chipset
22 ROM
23 storage
24 audio system
25 video subsystem
26 communication module
27 input/output interface
31 EC
32 input device
33 power supply circuit
34 battery
35 heat dissipation mechanism
36 power switch
252 display
351 temperature sensor
352 drive circuit
353 cooling fan

What is claimed is:

1. An information processing apparatus comprising:
a host system configured to operate using any one-stage power mode among multi-stage power modes different in power consumption from each other, wherein
when executing processing of a specific application as a predetermined specific application program, the host system measures a processing speed of the specific application, and
when the processing speed is lower than a predetermined reference speed, the host system upgrades an operating mode as a power mode used for the operation to a power mode higher in power consumption.

2. The information processing apparatus according to claim 1, wherein when finishing the processing of the specific application, the host system restores the operating mode to an operating mode at startup of the specific application.

3. The information processing apparatus according to claim 1, wherein
the processing of the specific application includes a process of acquiring output information in response to input information using a language model, and
the host system measures a speed at which the output information is provided, as the processing speed.

4. The information processing apparatus according to claim 1, wherein when the operating mode is a power mode lower in power consumption than a power mode highest in power consumption among the multi-stage power modes and the processing speed is lower than the predetermined reference speed, the host system displays an inquiry window on a display to inquire about the upgrading before upgrading the operating mode.

5. The information processing apparatus according to claim 4, wherein when the operating mode after being upgraded is used and the processing speed is higher than the predetermined reference speed, the host system displays a second inquiry window on the display to inquire about a downgrade to a power mode lower in power consumption.

6. A control method for an information processing apparatus configured to operate using any one-stage power mode among multi-stage power modes different in power consumption from each other, the control method comprising:
a step of measuring a processing speed of a specific application when executing processing of a specific application as a predetermined specific application program, and
a step of upgrading an operating mode as a power mode used for the operation to a power mode higher in power consumption when the processing speed is lower than a predetermined reference speed.
